(19) United States
(12) Patent Application Publication
(10) Pub. No.: US 2023/0156158 A1
(43) Pub. Date: May 18, 2023

(54) METHOD AND SYSTEM FOR DETECTING INVENTORY ANOMALIES USING CAMERAS

(71) Applicant: 6 River Systems, LLC, Waltham, MA (US)

(72) Inventors: William Moyne, Somerville, MA (US); Christopher Cacioppo, Somerville, MA (US); Dimitrios Nikitopoulos, Boston, MA (US)

(21) Appl. No.: 17/529,259

(22) Filed: Nov. 17, 2021

(51) Int. Cl. H04N 7/18; G06K 9/62; G06K 9/00; H04N 5/247; H04N 5/232; G06Q 10/08

(52) U.S. Cl. CPC H04N 7/181; G06K 9/6201; G06K 9/00771; H04N 5/247; H04N 5/23206; H04N 5/23229; G06Q 10/087

(57) ABSTRACT

Disclosed are systems and methods for monitoring inventory within a warehouse using mediate data streams. A server monitors and manages camera data streams for particular footage or segments of interest associated with exceptions of product inventory, such as misplaced or missing products. The server receives media data from cameras of a warehouse. The server may receive or detect an exception, which indicates the nature of the exception, the product, and other information. In response, the server performs certain actions, including selecting or identifying target cameras that produced footage of the product. The server extracts segments of the media from the selected cameras according to timestamps associated with the exception. The server then sends the segments to a client device for review, and stores the segments into a database.

### TECHNICAL FIELD

This application relates generally to tracking inventory in a warehouse and detecting anomalies based digital media received via cameras.

### BACKGROUND

Warehouses routinely employ a constellation of fixed-location cameras to monitor inventory and individuals. Managers or quality assurance (QA) associates review the cameras' footage to identify errors in current/prior shipments or to recognize ongoing root causes in repeating errors. But individuals cannot realistically store and review all available footage from all available cameras produced every day. Employing an “always-on” approach is infeasible for most warehouses, because of the high storage demands and computationally-intensive routines for the large volume of media data (e.g., many hours of high-resolution video footage) produced by many cameras (required to cover the extremely large footprint of a typical warehouse).

### BRIEF DESCRIPTION OF THE DRAWINGS

The accompanying drawings constitute a part of this specification and illustrate embodiments of the subject matter disclosed herein.

FIG. 1A illustrates a system for monitoring warehouse operations and order fulfillment, according to an embodiment.

FIG. 1B illustrates a diagram of a pick path of an autonomous vehicle of the system through the warehouse, according to an embodiment.

FIG. 2A shows an autonomous vehicle, according to an embodiment.

FIG. 2B shows a block diagram illustrating components of the autonomous vehicle system, according to an embodiment.

FIG. 2C shows the autonomous vehicle configured with multiple containers, according to an embodiment.

FIG. 3A shows machine-executed operations of executing a method for identifying an exception associated with a product during warehouse operations, according to an embodiment.

FIG. 3B shows optional operations of the method that may be triggered according to the operations of the method, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

A system described herein may monitor order fulfillment or track inventory within a warehouse where a server may intelligently monitor camera data streams for particular footage or segments of interest of an exception or potential exception. The system may intelligently parse media data into less-computationally demanding segments of interest containing footage of the exception for downstream analysis and long-term storage. A server receives media data streams from multiple cameras situated around a warehouse. The media data includes any machine-readable data (e.g., computer file, data stream) produced by the cameras. The media data may include any combination of continuous video, still image, and a series of still images. The footage includes the content captured within the camera's view and represented by the media data. At times, the server receives an indication of an order exception associated with a particular product in the order. The exception indicates to the server that an issue with the product arose while the warehouse was fulfilling the order. The exception triggers the server to perform certain actions, including selecting or identifying a set of cameras that produced footage of the particular product, autonomous vehicles, or workers involved in fulfilling the order. The server extracts one or more segments of the media data from one or more of the cameras in the selected set of target cameras according to timestamps associated with the exception. The server identifies these interesting segments using the media data received from the identified set of target cameras, sends the segments to a client device for review, and stores the segments into a database.

For example, the warehouse system receives an order for a pack of green pens. A worker pulls pens from a bin and into the container or tote of an autonomous vehicle, which makes numerous stops for product transfer along a picking path around the warehouse. After completing the order list, the autonomous vehicle proceeds to a packout station. The server may receive an exception indicating that the tote includes purple pens (rather than green pens) or the green pens are missing from the tote. The exception triggers the server to identify the relevant cameras that captured footage of the pens, from replenishment of the bin to transport of the collected products to packout. The server parses the certain segments of interest involving the pens from the media data based on one or more timestamps received with the exception. The server transmits the segments, culled from the set of target cameras, to a QA worker's computer for review for a root cause of the exception.

As another example, the server may instruct the autonomous vehicle to follow a particular pick path defining the route for traversing the warehouse. Along the pick path, the autonomous vehicle will, for example, automatically pick one or more products, meetup with a worker (e.g., picker) who manually picks a product, and proceed to the packout station after picking the items as instructed by the server. In some cases, the autonomous vehicle may be delayed due to, for example, being blocked, stuck, disabled (e.g., broken wheel, low on power), lost, or awaiting the picker for a prolonged period of time. The delay may be based on one or more time-based or condition-based exception triggers. For instance, the autonomous vehicle or warehouse worker may send the exception to the server indicating the delayed condition of the autonomous vehicle including certain information about the autonomous vehicle's condition (e.g., broken, lower power). The server or other computing device may automatically determine the delayed condition of the autonomous vehicle based upon one or more timers and corresponding timing thresholds, such that the server or other computing device generates the exception when the autonomous vehicle fails to arrive at a location (e.g., meetup with worker, arrive at a location of the product), perform an operation (e.g., pick a product and place the product in the tote), and/or traverse the pick path (e.g., arrive at the packout station) within the one or more time thresholds. The exception may trigger the server to identify the relevant cameras having a field of view that captured footage of an area of the warehouse for a transfer of a product (e.g., where the product was automatically or manually transferred to/from the autonomous vehicle on the pick path) or footage of an area for a transfer of the product that was unsuccessful or delayed (e.g., where the server determined that the product was to be automatically or manually transferred to/from the autonomous vehicle on the pick path). In this way, the exception may prompt the warehouse workers to review the footage to determine why the products of an order were not picked from the area as scheduled (e.g., pallet blocking the pick, aisle closed). The workers reviewing the footage may enter confirmation inputs containing further details about the identified exception, as received or detected at the server.

The exception may indicate an issue associated with a particular order product, such as an incorrect product being pulled and added to an order, or that a product was missing as indicated by an order list, or that a product was not available to be pulled due to an empty inventory bin. A worker may manually generate the exception by entering one or more exception commands into a user interface of a client device. For example, during order fulfillment, an autonomous vehicle receives products into a container or tote from inventory bins, which the autonomous vehicle delivers to a packout station for boxing and shipping. In this example, a worker at the packout station evaluates the products in the tote while packing up the order for shipment to confirm whether the tote includes the correct products. If the worker determines that the tote includes an incorrect product or a missing product, then the worker enters an exception input indicating that the wrong product was included in the order.

In some cases, the server or other computing device of the system (e.g., client computer, autonomous vehicle) may automatically detect the exception using the media data from cameras or product data for the particular product. The server may perform object recognition or computer vision operations using the media data from one or more cameras, which may include fixed cameras situated around the warehouse or mobile cameras coupled to the autonomous vehicles. The server may compare expected images of the media data against expected images to determine whether the level of similarity satisfies one or more similarity thresholds (sometimes referred to as “detection threshold(s)”). For example, the server may compare expected image data associated with the product, such as an image of the barcode or the relative height of the bin from which the product was retrieved against the image data in the media data. The server may detect the exception when the level of similarity satisfies (or fails) the preconfigured similarity threshold or detection threshold. In addition or as an alternative to comparing images of the media data, the server (or other computing device) may extract and compare certain image data (e.g., metadata), which the server extracted from the actual image itself or from machine-readable data containing the image (e.g., metadata of computer file or data stream containing the image). For example, the server may execute an algorithm that extracts information from the images (e.g., executing a barcode detector) and compares the extracted information.

I. Components and Operations of Illustrative Systems

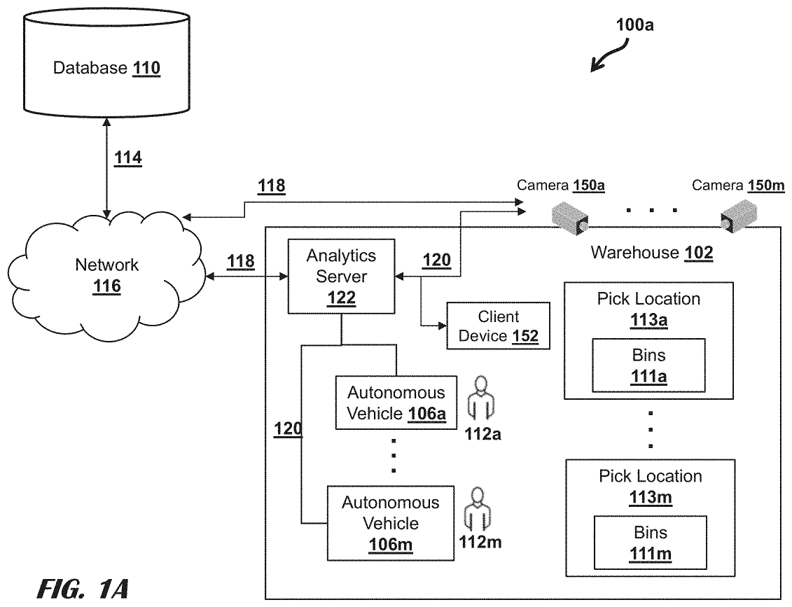

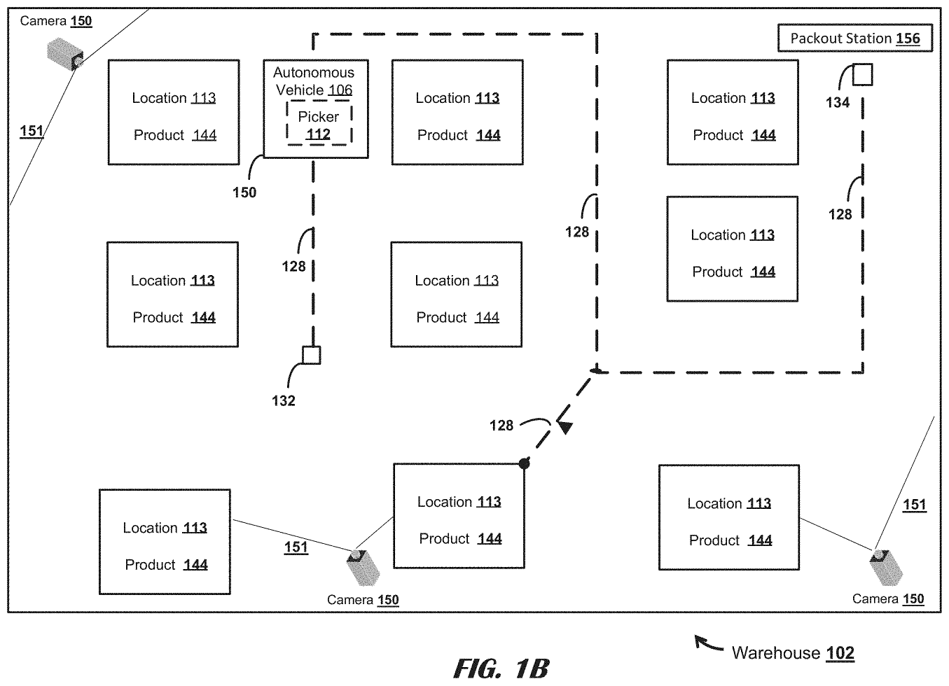

FIG. 1A illustrates a system 100a for monitoring warehouse operations and order fulfillment, according to an embodiment. The system 100a includes one or more databases 110 connected to a communications network 116. The communications network 116 connects to an analytics server 122 associated with a warehouse 102. The warehouse 102 may contain autonomous vehicles 106a to 106m (collectively referred to as autonomous vehicle(s) 106), pickers 112a to 112m (collectively referred to as pickers 112), pick locations 113a to 113m (collectively referred to as pick locations 113), shelves/racks/bins 111a to 111m (collectively referred to as bin(s) 111), cameras 150a to 150m (collectively referred to as camera(s) 150), and any number of client devices 152 associated with pickers 112, managers, or other personnel of the warehouse 102. Embodiments may include or otherwise implement any number of devices capable of performing the various features and tasks described herein. For example, FIG. 1A shows the analytics server 122 as a distinct computing device in the warehouse 102. In some embodiments, the analytics server 122 may be located in a different warehouse or capable of communicating with analytics servers 122 in various warehouses 102. Embodiments may comprise additional or alternative components, or may omit certain components, and still fall within the scope of this disclosure.

FIG. 1B illustrates a diagram of a pick path 128 of an autonomous vehicle 106 through the warehouse 102 with various pick locations 113. One or more workers (e.g., picker 112) pick products 144 stored in bins 111 or shelves at particular locations 113 along the pick path 128 and load the picked products 144 on the autonomous vehicle 106. The picker 112 may travel with the autonomous vehicle 106 or the autonomous vehicle 106 may autonomously traverse the pick path 128 to a packout station 156, where a worker (e.g., picker 112, QA worker, manager) unloads, reviews, and packs the products 144 on the autonomous vehicle 106 for shipping. The picker 112 or other worker may also travel with the autonomous vehicle re-routed to a healing station, when the autonomous vehicle 106 contains a product 144 associated with an exception and rerouted for further review by the QA worker, manager, or other worker.

The analytics server 122 may be configured for robotics to replace or assist the pickers 112. The robotic autonomous vehicle 106 may move autonomously throughout the warehouse 102 or storage facility. When moving autonomously, the autonomous vehicle 106 can move alongside the picker 112 or independently of the picker 112 to locations 113 in the warehouse 102. The robotic autonomous vehicle 106 may pick products 144 from bins 111 or shelves and load the picked products 144 onto the autonomous vehicle 106.

The autonomous vehicles 106 are located in the warehouse 102 and controlled by the analytics server 122 via the communications link 120. Pickers 112 may work alongside the autonomous vehicles 106 to perform operations, such as picking products 144 from bins 111 in the warehouse 102 and place those products 144 in the autonomous vehicle 106, replenishing bins 111 in the warehouse 102 by stocking products 144 on the bins 111 using the products 144 in an autonomous vehicle 106, and removing products from the autonomous vehicle 106 such that the products may be unloaded and packaged for shipping. The autonomous vehicle 106 is robotic and has autonomous operation based on instructions communicated from the analytics server 122. In some embodiments, the autonomous vehicle 106 may be manually operated by the picker 112, who may push, pull, drive, or otherwise move the autonomous vehicle 106 around the warehouse 102. For example, the autonomous vehicle 106 may have a shopping cart configuration. A manually-operated autonomous vehicle 106 may still use other components for communicating with the analytics server 122 and the picker 112, such as a screen for communicating information to the picker 112 from the analytics server 122.

The databases 110 store and manage data records of various products 144 or other information about warehouse 102 operations. For example, the database 110 may store product quantities, product locations, product shipping schedules, product manufacturer information, and the like. The products in the warehouse 102 may be collected, loaded, unloaded, moved, stored, or otherwise transferred at various areas for points of transfer within the warehouse 102 along the pick path 128. In some cases, the pick path 128 includes areas where the autonomous vehicle meets with a worker to manually pick the product 144. The database 110 may also store data records of various types of data indicating a quantity of a product and a location of a product in the warehouse (e.g., in a bin 111 at a particular pick location 113). The pick locations 113 may contain bins 111 of one particular product 144 or of multiple products 144. The database 110 may also store and manage data records of about the storage locations (e.g., shelves, aisles, bins 111) and images (e.g., product image, barcodes) of product inventory within the warehouse 102.

The database 110 may further contain information about the cameras 150. The data records about the camera 150 may indicate the properties of the camera 150, including any number of extrinsic properties (e.g., location, orientation of the camera 150) and any number of intrinsic properties for relating or mapping camera coordinates or pixel coordinates in the image or video frame (e.g., camera's 150 field of view 151 within the warehouse 102). The database 110 receives and stores data streams of media data (e.g., video, audiovisual, still image) from each camera 150, which the database 110 may receive directly or via the analytics server 122.

The analytics server 122 may update data records in the database 110 in real time (or near real time) as products are being stocked and picked from pick locations 113 (including bins 111) in warehouse 102. Additionally or alternatively, the analytics server 122 may update data records in database 110 periodically (e.g., daily, monthly, quarterly). In some configurations, data records in database 110 are updated in response to trigger conditions. For example, a triggering condition arises when a shipment of a particular product arrives at the warehouse 102, at which time a product is identified by a picker 112 as being out of stock.

The database 110 may store, update, or otherwise manage the media data according to instructions from the analytics server 122. The analytics 122 server or the database 110 may store media data from one or more cameras 150 in a particular non-transitory storage location for short-term review (e.g., review queue) until a security user of the warehouse 102 reviews the media data through a GUI of the client device 152. The security user may enter inputs into the client device 152 indicating portions of the media data for long-term storage in the database 110. Additionally or alternatively, the analytics server 122 may dynamically determine certain portions of the media data that require immediate or later review by the security user. The analytics server 122 may store these portions of the media data into the review queue of the analytics server 122 or database 110.

The database 110 is coupled via communications links 114, to communications network 116, and via communications link 118 to the analytics server 122 associated with the warehouse 102. In some embodiments, the database 110 is connected to the cameras 150. The communications network 116 may be a public or private network, and the communications links 114, and 118 that connect to communications network 116 may be wired or wireless. Non-limiting examples of the communications network may include: Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols. Similarly, the analytics server 122 is coupled to the autonomous vehicles 106, cameras 150, and client device 152 via communication links 120. The communication links 120 may be a public or private network, and may be wired or wireless. Non-limiting examples of the communication links 120 may include: Local Area Network (LAN), Wireless Local Area Network (WLAN), Metropolitan Area Network (MAN), Wide Area Network (WAN), and the Internet. The communication over the communication links 120 may be performed in accordance with various communication protocols, such as Transmission Control Protocol and Internet Protocol (TCP/IP), User Datagram Protocol (UDP), and IEEE communication protocols.

The analytics server 122 is associated with the warehouse 102 and may be physically located at the warehouse 102 or located remotely from the warehouse 102. In the schematic embodiment shown in FIG. 1A, the analytics server 122 is shown as being located in the warehouse 102, which may represent a physical and/or remote location of the analytics server 122 or its functionality, though the analytics server 122 may be located in a remote location. The analytics server 122 may be implemented as a distributed system or as a single device. In the case of a distributed system, one or more processors located outside the warehouse 102 or in other devices may be, and sometimes are, used to perform one or more operations attributed to the analytics server 122 in this embodiment.

The analytics server 122 may generate instructions to retrieve one or more products 144 in the bins 111 from one or more pick locations 113 to complete an order or request from a customer (e.g., online order, pick list, customer's list, grocery list, shopping list). When the analytics server 122 receives an indication that a product in an order has shorted, the analytics server 122 may query the database 110 and retrieve pick locations 113 that store the same product. The analytics server 122 will instruct the picker to pick the product at the new pick location 113 by updating the pick path 128. Additionally or alternatively, the analytics server 122 may query the database 110 and retrieve other substitute products (and substitute product locations) to replace the product that has been shorted and update the pick path 128. Additionally or alternatively, the analytics server 122 may store a lookup table in local memory mapping acceptable substitute products of particular products, alternate pick locations of particular products, and the like. The instructions can indicate a pick path 128 to the autonomous vehicle 106, indicating the locations 113 within the warehouse 102 for the picker 112 to find and collect products 144 for orders according to an order list received from the analytics server 122.

The autonomous vehicle 106 may communicate with the analytics server 122 and/or the database 110. The autonomous vehicle 106 receives instructions from the analytics server 122 and executes the instructions to route the picker 112 to particular pick locations 113 in warehouse 102. The analytics server 122 may cause instructions to display on a user interface of the autonomous vehicle 106 or the GUI of the client device 152. Additionally or alternatively, pickers 112 may utilize the client device 152, such as a mobile device or wearable device (e.g., earpiece, glasses, watch, wrist computer), to receive instructions and/or the notification from the analytics server 122. In other embodiments, the autonomous vehicles 106 receive instructions and/or notifications from the analytics server 122 and transmit the instructions and/or notification to the client devices 152 of the pickers 112.

The instructions may include a plurality of tasks or units of work. The tasks may include picking at least one product (e.g., from a bin 111), a product identifier, a quantity of the product, and location data (e.g., pick location 113) for the respective product. The instructions may indicate the pick path 128 (e.g., route) to pick products, location data identifying one or more locations (e.g., pick locations 113, bins 111 at a pick location 113) to pick products, product data identifying one or more products to be picked from particular bins 111, and corresponding order information (e.g., which products go in which containers/portions of containers on the autonomous vehicle 106). The various types of data (e.g., product data, media data, storage location data, autonomous vehicle data, camera data) that include fields that indicate, for example, a product identifier, media data, a scan of the product identifier, an product image, a bin identifier associated with the product (e.g. identifier of an inventory bin within which the product is stored on a warehouse shelf, or identifier of a tote bin within which the product is transported on an autonomous vehicle), an autonomous vehicle identifier for the autonomous vehicle, a worker identifier, a worker image, camera identifiers, and one or more timestamps, among others.

The autonomous vehicle 106 may receive instructions from the analytics server 122 and display the pick path 128 to the picker 112 assigned to the autonomous vehicle 106. The instructions routing the autonomous vehicle 106 may indicate an order (e.g., a sequence) to provide or display the tasks for the path such that the tasks for individual products are provided or displayed one at a time, for example, in sequential order through an interface on the autonomous vehicle 106. The instructions may interleave picking products of various orders (e.g., lists of products for particular customers) to minimize the time for pickers 112 to pick products in the warehouse 102. The autonomous vehicle 106 may display, using the instructions, one individual task at a time as a picker 112 progresses through the path such that upon completion of a first task (e.g., first product 144 at a first bin 111a at a first pick location 113a), the autonomous vehicle 106 displays a second task (e.g., a second product at a second bin 111b at the first pick location 113a, or a second product 144 at a second bin 11b at a second pick location 113b).

While the picker 112 is being routed to a pick path 128, the analytics server 122 can dynamically revise (re-route) the path, for example, in response to a product being unavailable (e.g., shorted), and to incorporate an alternate pick location 113 in the pick path 128 (e.g., a product may be restocked at an alternate pick location, the alternate pick location may have surplus products). Additionally or alternatively, the analytics server 122 may incorporate a substitute product (e.g., at an alternate pick location) in the pick path 128. The analytics server 122 may dynamically revise the pick path 128 to an alternate pick location based in part on one or more completion scores of multiple orders on the autonomous vehicle 106, a distance to the alternate pick location, a time to traverse to the alternate pick location 113, a priority of orders on the autonomous vehicle 106, and the like.

In some configurations, the analytics server 122 determines one or more acceptable substitute products, if a particular product is short in inventory. In determining acceptable substitute products, the analytics server 122 calculates acceptance probability scores (e.g., a likelihood that the user and/or customer will accept or agree to the available substitute product). The analytics server 122 may algorithmically or statistically determine acceptance probability scores using, for example, products, product classes, data associated with previous substitutions accepted by a user or group of users, previous substitutions accepted by one or more other users (e.g., similar users, group profile) and/or product ranking data. The analytics server 122 can generate weighted scores for products and substitute products. The weighted score may include a combination of a distance metric and an acceptance probability score for a product and substitute product. The analytics server 122 can determine and assign a weight value to the distance metric, acceptance probability score and/or product characteristics based in part on user preferences, store or retailer preferences and/or the characteristics of the missing product.

The autonomous vehicle 106 may communicate with the analytics server 122 to provide product status information (e.g., exception indicators, whether a product at a pick location 113 has shorted), completion of tasks (e.g., product picks) associated with the pick path 128, and receive routing instructions for navigating through the warehouse 102 to bins 111 at pick locations 113. In some configurations, the autonomous vehicle 106 may communicate with the database 110 to provide offline access to inventory data, product data, and/or substitute product data. The analytics server 122 may measure completion (fulfillment) of an order based on various order attributes. In one configuration, completion of an order occurs when the order has arrived at a packing station so that the order can be packaged for a delivery service. In another configuration, completion of an order occurs when an autonomous vehicle 106 has completed the pick path 128.

The analytics server 122 also communicates with databases 110, autonomous vehicles 106, and client devices 152 associated with pickers 112 (e.g., mobile phones, personal data assistants (PDA), tablet computers, handheld scanners, or wearable devices). The communications may include retrieving, updating, and routing (or re-routing) the autonomous vehicles 106, exchanging media data, and communicating instructions associated with managing the media data. The analytics server 122 may monitor the order fulfillment and track the product inventory within the warehouse 102, which includes receiving the media streams from the cameras 150 and performing various operations for particular footage or segments of interest in the media data of certain cameras 150. The cameras 150 are situated throughout the warehouse 102. Optionally, a camera 150 may be situated on or be a component of the autonomous vehicle 106.

In some embodiments, the analytics server 122 executes software programming dynamically parse the media data into shorter segments of footage for review, analysis, and long-term storage. In certain circumstances, the analytics server 122 receives an exception indicator that indicates an exception associated with a particular product in the order. A worker of the warehouse 102 may input the exception indicator into the client device 152, or a device of the system 100a may automatically detect and generate the exception based upon a computer vision operation or other machine-learning function.

The analytics server 122 performs one or more actions using information contained within the exception. The exception information may include, for example, the associated product identifiers, an identifier of the autonomous vehicle 106, or one or more timestamps or other information indicating relevant portions of the media data. The analytics server 122 selects or identifies a set of one or more cameras 150 that captured and generated footage of the autonomous vehicle 106, the picker 112 (or other personnel), or other footage capturing the particular product as the product traversed from a pick location 113 or bin 111 where the product 144 is stored along the pick path 128 to the end point 134 of the autonomous vehicle 106. The analytics server 122 extracts one or more segments of the media footage from the determined set of one or more of the cameras 150 according to the timestamps of the exception. The analytics server 122 may store the segments into the review queue of the analytics server 122 or the database 110 and transmits the segments of the media data to the client device 152 for display via a GUI for user review.

The client device 152 may be any computing device capable of displaying information to pickers 112 or other users of the system 100a. The client device 152 may include software programming for receiving, displaying, and navigating the display of the media data. The client device 152 may further provide various instructions or queries to the analytics server 122 or database 110, including user instructions confirming to the analytics server 122 that a particular segment of media is indeed associated with an exception (e.g., captured footage of misplaced inventory, captured footage of theft).

The analytics server 122 receives certain types of information before or along with receiving the exception, which the analytics server 122 uses to detect the exception or perform certain responsive actions. The analytics server 122 can additionally or alternatively use the information received from the cameras 150 or other devices (e.g., client device 152) of the system 100a to cross-reference (or correlate) with other information stored in the database 110. For instance, the analytics server 122 can cross-reference the product data indicating the location 113 or the bin 111 of the product 144 against camera data containing camera information indicating the products 144 or bins 111 that are situated in or traverse the cameras' 150 field of view 151.

The database 110 may store camera data records for each of the cameras 150 and product data for each of the products 144. The camera data for a particular camera 150 may include, for example, the camera information indicating the locations 113, bins 111, and/or products 144 situated in or having a pick path 128 traversing the particular camera's 150 field of view 151. The product data may include, for example, the product information indicating the location 113, bin 111, and/or the pick path 128 for the particular product 144. In response to an exception or at a preconfigured time interval, the analytics server 122 may reference the database 110 and correlates the camera data and the product data to determine one or more data intersections between the camera data and product data. Using these data intersections, the analytics server 122 may identify the set of target cameras 150 that potentially generated media data including footage of the particular product 144. The analytics server 122 may then perform further operations associated with the media data generated by this identified set of target cameras 150. For instance, the analytics server 122 may cross-reference and correlate the camera data for the plurality of cameras 150 of the warehouse 102 against the product data for a particular product 144, such as the product 144 associated with an exception received by the analytics server 122. For each particular camera 150, the analytics server 122 may correlate the product data of the product 144 (e.g., location 113, bin 111, and/or the pick path 128 for the particular product 144) against the camera data of the particular camera 150 (e.g., locations 113, bins 111, products 144 situated in or having a pick path 128 traversing the particular camera's 150 field of view 151). Based upon these correlations, the analytics server 122 may determine instances of data intersections where the camera data of particular cameras 150 intersect with the product data. For example, the camera data may expressly indicate that the product 144 is in the camera's 150 field of view 151. As another example, the camera data may indicate the location 113, bin 111, or pick path 128 in the camera's field of view 151 matches or otherwise corresponds to the location 113, bin 111, or pick path 128 of the product 144 in the product data. The analytics server 150 may identify the set of target cameras 150 based upon the camera data having the data intersections with the product data.

With reference to FIG. 1B, the pick path 128 can include or correspond to an original or initial path generated based on the pick locations 113 of products of one or more orders. The pick path 128 can provide the route through the warehouse 102 for the autonomous vehicle 106 to follow, and select or retrieve the corresponding products 144 of the order list received from the analytics server 122. The pick path 128 may correspond to a minimal or smallest total distance for the autonomous vehicle 106 to travel through the warehouse 102 to select and/or retrieve the product 144 for one or more orders from the various pick locations 113 within the warehouse 102. The autonomous vehicle 106 can execute the instructions to collect the product 144 in a determined ordering, for example, sequential order based in part on a position with the pick path 128, a current location 150 in the warehouse 102, and/or a location 113 of the product 144.

The cameras 150 may include fixed or mobile cameras 150, situated around the warehouse 102 or coupled to the autonomous vehicle 106. Each camera 150 generates media data containing various types of digital media (e.g., video, audiovisual, still image), which the camera 150 transmits as a data stream to the analytics server 122 or the database 110 via one or more communications links 118, 120. The media data includes footage captured by the camera 150 within the field of view of the particular camera 150. The media data generated by the camera 150 may include metadata indicating aspects of the media data. For instance, the media data may include timestamp metadata that may correspond to timestamps contained within the exception indicators generated when fulfilling orders.

Each camera 150 may include the field of view 151. Field of view 151 is illustrated in FIG. 1B as having an angle, but the field of view 151 from camera 150 may have a 360 degree view. The camera 150 may be positioned so that field of view 151 focuses on one or more aisles, shelves, containers, autonomous vehicles, areas, stations, pickers, or other objects. In one example, the field of view may include a portion of a shelf, and the analytics server may analyze media data from the camera to detect when a picker reaches for a particular product in that portion of the shelf. In another example, the autonomous vehicle may have a camera having a field of view that changes as the autonomous vehicle traverses the warehouse, and the analytics server may analyze media data from the camera to detect when a picker reaches for a particular product in that portion of the shelf.

The autonomous vehicle 106 can execute instructions for a first location 113 for a first product 144 and wait to execute instructions for a second location 113 for a second product 144 until the autonomous vehicle 106 receives an indication that the first product 144 has been picked. Additionally or alternatively, the autonomous vehicle 106 may receive an indication that the first product 144 is unavailable and/or damaged. The pick path 128 can include a starting point 132 and an end point 134 with each of the pick locations 113 at different points along the path 128. The packout station 156 is situated at or near the end point 134, which includes a client device 152 operated by a packout user who performs a quality control review of the inventory on the autonomous vehicle 106, and then packs and ships the products 144 from the autonomous vehicle 106 to the destination. It should be appreciated that the pick path 128 can include a single location 113 or multiple locations 113 (e.g., two or more) with the number of pick locations 113 determined based in part on a number of products 144 picked for one or more orders.

The autonomous vehicle 106 can execute the instructions and traverse the pick path 128 selecting and retrieving the corresponding products 144 from the respective locations 113. In some circumstances, the analytics server 122 receives the indication of the exception associated with a product along the pick path 128, which may be manually inputted at the client device 152 or automatically detected by a device in the system 100a. The exception indicates an issue associated with a particular product 144 of the order, such as an incorrect product 144 being picked and added to the autonomous vehicle 106 or that the product 144 is missing from the order fulfillment.

The picker 112 or worker at the packout station 156 may manually generate the exception by entering one or more exception commands into the GUI of the client device 152. For example, during order fulfillment, the picker 112 picks the products 144 from a bin 111 and places the product 144 onto the autonomous vehicle 106, which follows the pick path 128 to deliver the products to the packout station 156 for boxing and shipping. In this example, the QA worker at the packout station 156 evaluates the products 144 on the autonomous vehicle 106 to confirm whether the autonomous vehicle 106 includes the correct products 144. If the QA worker determines that the autonomous vehicle 106 includes an incorrect product 144 or a missing product 144, then the QA worker enters an exception input indicating that the wrong product 144 was included to the autonomous vehicle 106 when fulling the order.

Additionally or alternatively, the analytics server 122 or other computing device of the system 100a (e.g., client device 152, autonomous vehicle 106) includes software programming for evaluating the products at various points of fulfilling the order and detecting exceptions in fulfilling the order. The analytics server 122 automatically detects the exception based upon the media data from the cameras 150 and/or product data for the particular product 144 as received from the client device 152 or as stored in the database 110.

In some embodiments, the analytics server 122 or another computing device may perform object recognition or computer vision operations using the media data from the one or more cameras 150. The analytics server 122 compares the media data (e.g., video, still images) against pre-stored expected media data in the database 110, determines a level of similarity between the observed media data and the expected media data, and determines whether the level of similarity satisfies one or more similarity thresholds.

For example, the analytics server 122 compares the expected media data associated with the product 144, such as an image of a barcode or the relative height of the bin 111 from which the product 144 was picked by the picker 112 against an observed image in the observed media data. The analytics server 122 detects the exception when the level of similarity satisfies (or fails) the preconfigured threshold.

As another example, the analytics server 122 analyzes a blob (corresponding to the picker 112) in the media data received from a particular target camera 150 to determine whether the blob indicates that the picker 112 reached for an expected bin 111 or performed an expected motion. The analytics server 122 compares the received media data (e.g., blob position, blob motion) against expected media data (e.g., expected blob position, expected blob motion) or the analytics server 122 applies object recognition software routines on the received media data to determine whether the position or motion of the picker 112 matches to an expected position or expected motion or falls within the preconfigured threshold.

The analytics server 122 or other computing device may automatically detect the exception using product data, in addition or as an alternative to using the media data. The analytics server 122 (or other device) performs comparison operations using the product data. The analytics server 122 references expected product data stored in the database 110 and compares the expected product data against the observed product data received for the product 144 from the client device 152 or the camera 150. For example, the analytics server 122 receives the stock-keeping unit (SKU) from the client device 152 or camera 150, as the observed product data or as the observed image, for the particular product 144 during packout or when the autonomous vehicle 106 places the product 144 into a storage tote of the autonomous vehicle 106. The analytics server 122 compares the observed SKU against the expected SKU stored in the database 110 to determine whether the correct or incorrect product 144 was picked and placed onto the autonomous vehicle 106. In a configuration, the analytics server 122 may analyze order data associated with the order to detect an exception. For instance, to detect a missing product exception, the analytics server 122 compares expected order data (e.g., expected number of products 144 in the order list) against the observed order data captured at the packout station 156 (e.g., observed number of products 144 collected by the autonomous vehicle 106).

In response to the exception indication, the analytics server 122 may perform any number of preconfigured responsive or remedial actions. The information received with the exception includes one or more timestamps that the analytics server 122 uses to identify portions or segments of interest from each target camera's 150 media data stream. The analytics server 122 may transmit these segments of interest to the client device 152 of a particular worker responsible for reviewing the footage, such as the manager or QA worker. The analytics server 122 may store these segments into long-term storage memory (e.g., database 110, memory storage of the analytics server 122) for later reference according to a retention policy. In some cases, the analytics server 122 or database 110 stores some or all of the media data streams from one or more cameras 150 into the review queue short-term storage memory location (e.g., database 110, memory of the analytics server 122) according to a short term storage policy, and stores only segments of interest selected by the worker using the client device 152 into the long term storage location according to the retention policy.

Optionally, the analytics server 122 may instruct the subset of target cameras 150 containing footage of the product 144 associated with the exception to adjust resolution quality or other aspect of media quality of the media data generated by the cameras 150, or the analytics server 122 adjusts the resolution quality of the media data received from the cameras 150. In some implementations, the analytics server 122 maintains real-time tracking data indicating the path and position of the autonomous vehicle 106 within the warehouse 102 and may instruct to the camera 150 to generate media data based upon the positon of the autonomous vehicle 106. For example, when the analytics server 122 determines that the autonomous vehicle 106 is at a particular position (e.g., aisle, bin 111) in the warehouse 102, the analytics server 122 then instructs the camera 150 to generate the media data in a high resolution.

In some implementations, the media data may be stored at a resolution quality based upon whether the media data is associated with an exception. For example, the cameras 150 generate the media data at a higher resolution, which the database 110 or analytics server 122 may store into the short-term or long-term storage memory. If the analytics server 122 receives an exception associated with the media data, then the media data is stored in the higher resolution. If, however, the analytics server 122 does not receive an exception associated with the media data, then the analytics server 122 degrades the quality of the media data and stores the media data at the lower resolution.

The cameras 150 may ordinarily generate media data in a lower resolution for bandwidth and/or storage considerations, and the analytics server 122 may adaptively instruct the target cameras 150 to produce high-resolution media data in response to receiving or detecting an exception when the picker 112 or autonomous vehicle 106 gathers the particular product 144 or when the autonomous vehicle 106 reaches the packout station 156. As an example, the analytics server 122 may treat the exception as a potential exception that should be confirmed by a worker. The analytics server 122 receives or detects the potential exception when the product 144 is placed onto the autonomous vehicle 106 (e.g., object recognition likelihood operation), and instructs the set of target cameras 150 to increase the target cameras' 150 resolutions or other aspect of the media quality. In this example, the analytics server 122 may determine that the picker 112 picked the product 144 from a bin 111 that is different from an expected bin 111 based upon the object recognition or computer vision operations, and detects the potential exception. At the packout station 156 or later time, the client device 152 of the manager or QA worker may receive the segments of media data having the higher resolution for manually reviewing the segments of media data to confirm and resolve the potential exception.

Additionally or alternatively, in some implementations, the analytics server 122 (or other computing device) may adaptively decrease or increase the resolution of the media data received from the target cameras 150. In such implementations, the analytics server 122 may receive high-resolution media data from the target cameras 150, where the resolution of the target cameras 150 remains fixed. The analytics server 122 may reduce the resolution of the media data or camera images received from the target cameras 150. In some cases, the analytics server 122 may increase the resolution (e.g., does not degrade, maintains the higher resolution) of the media data in response to receiving or detecting an exception.

The analytics server 122 may crop visual image or video in the media data to include an area of interest in response to receiving or detecting an exception. For instance, the field of view 151 of a target camera 150 may include a view of a long aisle at high resolution. When the analytics server 122 receives or detects an exception occurring at one end of the aisle (and not the other end of the aisle), then the analytics server 122 may crop the media data to include the image or video of just the end of the aisle (or proximity distance) relative to the location of the exception. In this way, the analytics server 122 and target camera 150 may generate and store high-resolution media data capturing the exception, and the media data has a smaller filesize compared to the filesize without cropping.

In some embodiments, the target cameras 150 can be configured to output two or more streams of media data having various different resolutions and/or fields of view 151, where the analytics server 122 may switch between the streams of media data from the target cameras 150, based upon the a relative location of the exception received or detected by the analytics server 122. In this way, the analytics server 122 need not perform expensive operations to transcode a large volume of video or images, which facilitates system scaling. This may also improve quality if the different resolutions are each using the original raw image.

In some embodiments, the analytics server 122 executes one or more mitigation actions. In response to receiving the exception, the analytics server 122 may transmit an alert notification to the client device 152 (e.g., mobile device) of a worker (e.g., picker 112, QA worker, manager) indicating the exception to the worker or the client device 152. The alert informs and instructs the worker to confirm whether the exception is genuine or a false positive. For instance, the analytics server 122 may execute the computer vision or objection recognition software routines that detect a potential exception, which triggers the analytics server 122 to transmit the alert to the client device 152. The alert may instruct the worker to confirm the potential exception is accurate and informs the worker that the media data segments of interest are stored into the review queue and awaiting review by the worker.

As another configuration, when a worker enters an exception to the analytics server 122 via the client device 152 (e.g., QA worker uploads the exception to the analytics server 122 at the packout station 156), the analytics server 122 sends a real-time alert to the client device 152 of the picker 112 who was responsible for fulfilling the order with autonomous vehicle 106. The alert indicates to the picker 112 via the GUI of the client device 152 the incorrect product 144 that the picker 112 actually picked and the correct product 144 that the picker 112 should have picked. The alert may also indicate the location 113 of the correct product 144. Alternatively, the analytics server 122 may transmit the alert directly to the autonomous vehicle 106, indicating a modified pick path 128 and location 113 for picking the correct product 144.

The analytics server 122 may update the information stored in the database 110 based upon the exception. When the picker 112 replenishes a particular bin 111, the analytics server 122 may receive the exception indicating that the bin 111 contains the incorrect inventory products 144. The analytics server 122 may determine that the product 144 was incorrectly replenished according to an automated object recognition or computer vision operation, using the media data of the one or more cameras 150 that capture footage of the picker 112 replenishing the bin 111. In some cases, the analytics server 122 may reassign the product data and bin 111 information in the database 110. For instance, the analytics server 122 updates which bin 111 a SKU is assigned to when products 144 of that SKU were replenished into the wrong bin 111.

II. Autonomous Vehicle

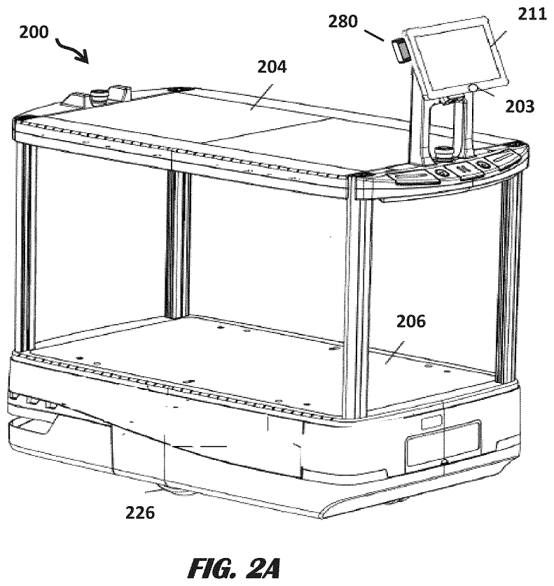

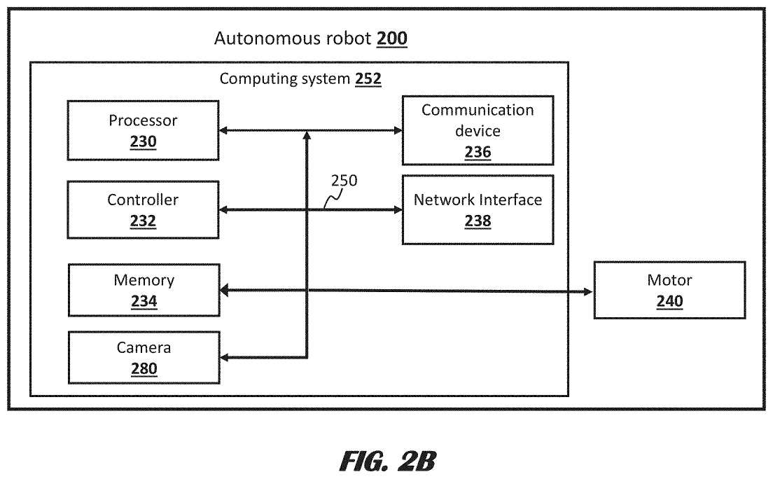

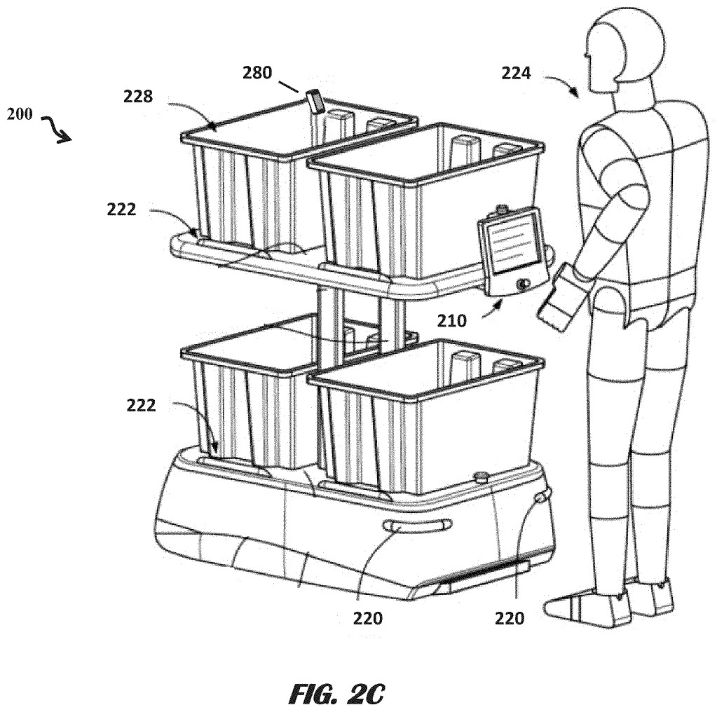

FIG. 2A shows an autonomous vehicle 200, according to an embodiment. The autonomous vehicle 200 has wheels 226, display 211, speaker 203, and two shelves 204, 206. Optionally, the autonomous vehicle 200 includes one or more cameras 280. In some instances, weighing scales (not shown) may be incorporated into the shelves 204, 206. For instance, the shelves may include pressure plates. The autonomous vehicle 200, through notifications displayed on display 211 and/or audio instructions provided via speaker 203, may notify a worker of the total weight of products on the shelves 204, 206 (e.g., the weight of the products on each shelf 204 and 206 respectively, the weight of combined shelves 204, 206) and notifications related to the exception or potential exception that indicates a missing or misplaced product. One or more totes (as described in FIG. 2C) can be, and sometimes are, transported on each of the shelves 204, 206 of the autonomous vehicle 200. The scales may have a tare feature such that the weight of totes on the scales can be zeroed. Eliminating the weight of the tote on the scale allows the analytics server to determine the weight of the products in the tote.

While a two-shelf autonomous vehicle 200 embodiment is shown, multiple autonomous vehicle 200 configurations are possible, with some autonomous vehicles 200 being implemented using a single shelf while other autonomous vehicles 200 have two or more shelves 204, 206. Each of the totes on the autonomous vehicle 200 may have several levels (layers, zones) for storing and transporting the picked products.

The autonomous vehicle 200 may be configured to determine product dimensions. For instance, a weighing autonomous vehicle may utilize shelves 204, 206 with scales to weigh the products. Additionally or alternatively, a measuring autonomous vehicle may carry one or more measuring devices (e.g., augmented reality measurement tools, rulers, measuring tape) and/or be configured with a camera 280 and imaging software such that the processor (230 in FIG. 2C) on the autonomous vehicle 200 may capture and determine certain aspects of the products (e.g., dimensions, weight, expected image). For example, the processor may perform object recognition to measure the product such that the imaging processing may recognize a product and even distinguish it from a hand of a picker. In some instances, the processor may support object recognition capabilities and/or be capable of executing the image processes. The processor may determine the dimensions of the product and communicate the product dimensions to the analytics server (122 in FIG. 1A).

Additionally or alternatively, the analytics server may receive image data (raw data, compressed data) from the camera 280 and perform object recognition to evaluate the products placed on the autonomous vehicle 200 and detect any exceptions. The camera 280 may capture the media data and transmit the media data to the analytics server to perform the various image processing operations (e.g., object recognition, computer vision) for detecting exceptions, as described herein.

The autonomous vehicle 200, through visual instructions displayed on display 211 and/or audio instructions provided via speaker 203, may transmit an instruction to place one or more products on an inspection station. For example, a picker assigned to an autonomous vehicle 200 may receive instructions from the autonomous vehicle 200 to pick a product to be inspected on route to a location (e.g., such as an inspection station, a subsequent product location, etc.) Additionally or alternatively, an administrative user (using a management console, for instance), may trigger an inspection. That is, a management console or other administrative device may transmit an instruction (via display 211, speaker 203, and/or wearable devices worn by the picker) to place one or more products on an inspection station or packout station, place one or more products on an autonomous vehicle 200 on route to a location, and the like. If the processor of the autonomous vehicle 200 or analytics server may automatically detect an exception based upon the media data of the camera 280 or receive the exception entered by the reviewing worker.

FIG. 2B shows a block diagram of the autonomous vehicle system 260 that may be used in implementing the systems and methods described herein, according to an embodiment. The computing system 252 of an autonomous vehicle 200 may include a processor 230, a controller 232, a memory 234, a communication device 236, a network interface 238, and one or more cameras 280. The autonomous vehicle 200 may also include a motor 240. Each of the components 230, 232, 234, 236, 238, 240, 280 may be interconnected, for example, using a system bus 250. General-purpose computers, network appliances, mobile devices, or other electronic systems may also include at least portions of the computing system 252.

The computing system 252 may receive and/or obtain information about a customer order (e.g., from the analytics server), including a list of products, the dimensions of the products, the weight of the products, characteristics of the products (a fragility score, a hazard score), the priority of the order relative to other orders, the target shipping date, the carrier pick up time, whether the order can be shipped incomplete (without all of the ordered products) and/or in multiple shipments, etc.

The controller 232 may be configured to send control signals to the motor 240 and/or other components of the autonomous vehicle 200 as described further herein. The motor 240 may be configured to convert electrical energy received from an electrical power source (e.g., battery, super capacitor, etc.) into rotations of the wheels (226 in FIG. 2B). The motor 240 propels the autonomous vehicle 200 such that the autonomous vehicle 200 moved autonomously and does not require being pushed or pulled by a human or other force.

The memory 234 may store information within the computing system 252. In some implementations, the memory 234 is a non-transitory computer-readable medium. In some implementations, the memory 234 is a volatile memory unit. In some implementations, the memory 234 is a non-volatile memory unit.

The memory 234 may store warehouse operation information. The warehouse operation information may include documented product dimensions, tote capacity (e.g., weight limit, product count limit), shelf capacity (e.g., weight limit, product count limit), and bin capacity (e.g., weight limit, product count limit). The memory 234 may also store product information such as a product name, a product description, a product image, and product storage location.

The processor 230 may be capable of processing instructions for execution within the computing system 252. In some implementations, the processor 230 is a single-threaded processor. In some implementations, the processor 230 is a multi-threaded processor. The processor 230 is capable of processing instructions stored in the memory 234.

The processor 230 in the autonomous vehicle 200 (and/or the analytics server 122 in FIG. 1A) may control the autonomous vehicle's 200 movement to/from one location (e.g., pick location) to the next location (e.g., unloading station, subsequent pick location). The processor may be in communication with controller 232 and/or motor 240. In the event the autonomous vehicle 200 becomes associated with a different worker (e.g., a worker at an unloading station or a second picker taking over picking for the first picker), the autonomous vehicle 200 may require the second worker to log in to the autonomous vehicle 200 (e.g., via the touch screen 211 in FIG. 2A) prior to the autonomous vehicle 200 providing guidance as to the next operation performed by the second worker.

In some implementations, at least a portion of the approaches described herein may be realized by instructions that upon execution cause one or more processing devices to carry out the processes and functions described herein. Such instructions may include, for example, interpreted instructions such as script instructions, or executable code, or other instructions stored in a non-transitory computer readable medium.

The network interface 238 may be configured to receive and transmit messages, instructions, and/or media data of the camera 280. The network interface 238 may be a wireless network interface capable of receiving commands and information from the analytics server and sending information (e.g., product locations) to the analytics server via wireless signals.

The network interface 238 may be configured to process signals from the analytics server and/or other autonomous vehicles in the warehouse. The network interface 238 may be, for instance, an Ethernet card, a serial communication device, e.g., an RS-232 port, and/or a wireless interface device, e.g., an 802.11 card, a 3G wireless modem, or a 4G wireless modem.

FIG. 2C shows the autonomous vehicle 200 configured with multiple containers 228 (sometimes referred to as “totes”), according to an embodiment. The autonomous vehicle 200 may display on screen 211 instructions for a picker 224. The instructions may instruct the picker 224 to travel to locations in the warehouse, search for particular bins at a particular location for particular products, and place products in the containers 228 or remove products from the containers 228 (e.g., unload at a particular bin/shelf). The picker 224 may place (or remove) the product in a particular container 228 based on lights 222, 220 indicating the particular tote. That is, the lights 222, 220 may illuminate, directing the picker 224 to place (or remove) the product in the indicated container 228. Additionally or alternatively, the display 211 may display instructions instructing the picker 224 which container 228 to place (or remove) the products.

Additionally or alternatively, one or more imaging systems (e.g., scanners) may operate in conjunction with (or replace) lights 220, 222. The imaging system may be used to measure the dimensions of products as the products enter the container and, in some embodiments, determine whether the picker 224 picked the correct product. For example, object recognition may be performed to recognize a product and determine whether the product matches to an expected product image. As discussed herein, the processor (230 in FIG. 2B) may support object recognition capabilities and/or be capable of executing the image processing operations for the media data received from the camera 280. Additionally or alternatively, the analytics server (122 in FIG. 1) may receive media data (raw data, compressed data) from the 280 and perform object recognition and exception detection for the products entering the containers 228. The image processing operations may confirm whether the picker 224 correctly picked the product that the picker 224 placed into the container 228. If the product is not placed into the container or the incorrect product was picked, the analytics server may detect an exception associated with the product.

III. Illustrative Methods of Operation

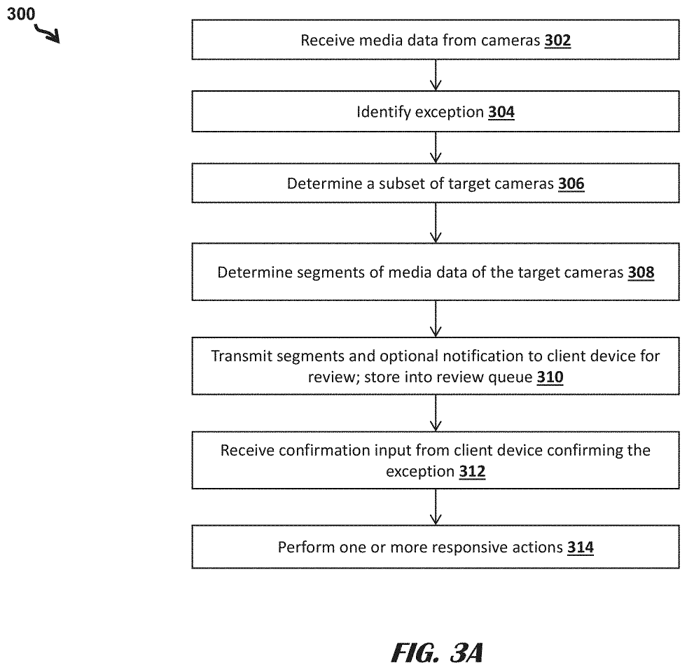

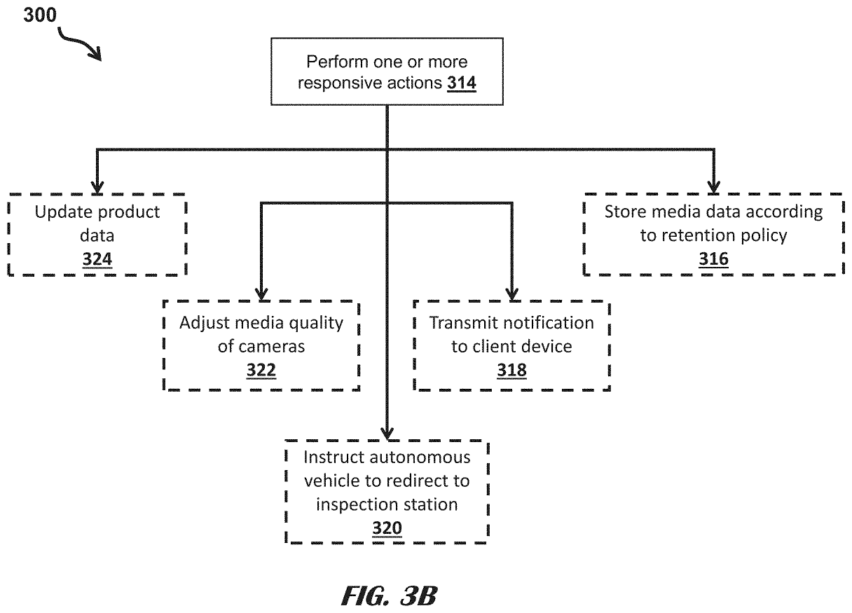

FIG. 3A shows machine-executed operations of executing a method 300 for identifying an exception associated with a product during warehouse operations, according to an embodiment. FIG. 3B shows optional operations of the method 300 that may be triggered, according to an embodiment. An exception indicator may include various types of data related to the particular product and the cause for the exception, which may include misplaced or missing products. The method may be implemented by an analytics server (or other computing device) associated with the warehouse and executes machine-readable software code for exception detection and product verification using media data received from various fixed or mobile cameras situated around the warehouse. Some embodiments may include additional, fewer, or different operations than those described in the method 300 and shown in FIG. 3A. The various operations of the method 300 may be performed by one or more processors executing on any number of computing devices.

In operation 302, the analytics server may receive the media data as data streams from the cameras. Each fixed camera is situated in particular position within the warehouse and configured to capture footage within a fixed or rotatable field of view relative to the camera's fixed position. The warehouse includes autonomous vehicles that autonomously or semi-autonomously navigate the warehouse to certain locations in the warehouse where products are stored in bins or shelves. The analytics server receives an order list indicating the products needed to fulfill a given order and generates a picking path as the route for the autonomous vehicle to traverse the warehouse. In some cases, the warehouse includes mobile cameras affixed or integrated to the autonomous vehicle, where the mobile camera captures a field of view relative to the surfaces or totes of the autonomous vehicle as the autonomous vehicle traverses the picking path.

The analytics server may receive the media data along with metadata or other form of data related to the media stream generated by the camera. The data related to the media stream includes information about the media stream, such as timestamps, camera information, product information, and other information the analysis server may reference to detect exceptions or determine a subset of target cameras that generated media data that includes footage related to the exception.

In operation 304, the analytics server may identify the exception associated with a product of an order while the warehouse operations fulfill the order. The analytics server may identify the exception by executing software programming that automatically detects the exception or by receiving an indication of the exception manually entered by the worker at another device. In some embodiments, the analytics server employs both automated and manual inputs for identifying the exception. In such embodiments, the analytics server identifies a potential exception using a first means of identifying exceptions, and the analytics server confirms the potential exception using a second means of identifying exceptions. As an example, the worker may enter an input indicating the potential exception, causing the analytics server to perform an image processing operation for confirming the exception. As another example, the analytics server detects the potential exception based upon the image processing operation, causing the analytics server to send an alert to a worker instructing the worker to review the media data to confirm the accuracy of the algorithmically detected potential exception.

The analytics server may identify the exception based upon the manual input from the worker. The analytics server receives an indication of the exception from the client device of the warehouse, as entered by the worker via a GUI of the client device. The analytics server may receive the indication input from the client device, such as a wearable device, a mobile device, a tablet, and/or a display on the autonomous vehicle indicating that an exception has occurred.

The analytics server may identify the exception algorithmically based upon the media data streams or other data values received from devices of the system. The analytics server may execute object recognition or computer vision operations to automatically detect the exception for the product by determining that the observed media data received from the cameras does not match to expected media data for the product stored in the database.

The analytics server may identify the exception at various points of the warehouse operation. As an example, the analytics server may identify the exception when a picker places the wrong product into the autonomous vehicle, when the media data from a fixed camera or camera of the autonomous vehicle contains image data that does not match expected image data for the particular product as indicated by the order list. As another example, at a packout station, a QA worker or client device of the packout station may scan or capture an image of the SKU of the product. The analytics server may detect the exception according to the input from the QA worker or based upon mismatched image data of the SKU compared to expected image data of the SKU or mismatched SKUs in the product data compared to expected product data in the database.

In operations 306 and 308, the analytics server may collect information associated with the exception in response to identifying the exception. In operation 306, the analytics server cross-references product data with camera data to determine a subset of one or more target cameras having a field of view that would have captured footage of the product within the media data as the product was transferred or the analytics server scheduled to be transferred. The transfer of the product may be as the autonomous vehicle picked and/or moved the product from the bin or shelf to the packout station for a pick operation, or from the autonomous vehicle to the bin or shelf for an inventory replenishment operation. The transfer of the product may include any collection or unloading or movement of product between autonomous vehicles (or between totes thereof), to/from a sorting wall, loading dock, inspection station, or other facilities within the warehouse. The product data may indicate the location where the product is stored, and the camera data may indicate the products, workers, or autonomous vehicles that enter the camera's field of view. By cross-referencing the camera data with the product data for the product indicated by the exception, the analytics server determines each camera that captured footage of the product in the media data.

In operation 308, for each of the cameras, the analytics server may determine a segment of the media data related to the product exception. The analytics server receives or determines one or more timestamps associated with the occurrence of the exception, such as when the exception is identified (in operation 302) or when the product reaches the packout station. The analytics server may also receive one or more timestamps that are associated with each of the significant product transfers that involved the product within a relevant time period, such as all pick operations or replenishment operations which occurred on the same day or same week for that inventory location in the warehouse, prior to the exception occurring. The analytics server parses or stores a segment of interest from the particular camera's media data using the timestamp. For example, the server may determine the segment of interest using the timestamp as a point of reference and some preconfigured period of time preceding and/or following the timestamp.

In operation 310, the analytics server may transmit each of the segments to the client device of a reviewing worker (e.g., QA worker, warehouse operations manager) and/or an optional notification alert to the client device instructing the reviewing worker to review the segments. The analytics server may further store the segments into a review queue accessible to a client device of the reviewing worker, where the review queue may be any storage memory configured for shorter-term storage in accordance with a retention policy.

In operation 312, the analytics server may receive a confirmation input from the client device indicating the reviewing worker's confirmation that the identified exception (in operation 304) was accurate and/or to input additional information about the identified exception. The reviewing worker reviews, via the GUI of the client device, the segments of interest from each of the cameras. In some cases, the reviewing work determines whether the identified exception was accurately determined to be an exception. If the reviewing worker determines that the exception is accurate (e.g., sees the product was missing, sees the product was misplaced, sees the wrong product was picked), then the reviewing worker enters a confirmation input into the client device, and the client device transmits the confirmation input to the analytics server. Additionally or alternatively, in some cases, the reviewing worker may identify information about the identified exception (e.g., worker picked from wrong inventory bin, intended product, picked product, when the exception was detected) and/or cause of the identified exception (e.g., reviewing worker enters a confirmation input indicating that the identified exception occurred at the packout station because the picker picked the wrong product). The analytics server may perform one or more responsive actions (in operation 314) in response to the confirmation input from the reviewing worker.

Alternatively, if the reviewing worker determines that the exception is inaccurate, then the reviewing worker enters a resolution input into the client device indicating that the exception is resolved or non-existent. The analytics server may remove the segments from the review queue and the method 300a halts.

In some embodiments, the analytics server may determine whether the outputted results of comparing the observed media data and expected media data satisfy one or more thresholds when executing the media processing operations (e.g., object recognition, computer vision functions). The analytics server may evaluate whether the comparison results has satisfied a threshold, whether the number of exceptions (or non-exceptions) has satisfied the threshold, whether a duration of time has satisfied the threshold, and the like. If the analytics server determines that the results fail to satisfy the one or more thresholds, then the analytics server determines that the exception is accurate. If the reviewing worker determines that the results satisfy the thresholds, then the analytics server determines that the identified exception is inaccurate.

In operation 314, the analytics server may perform one or more responsive actions triggered by the confirmation of the identified exception (in operation 304), such as those operations shown in FIG. 3B

In operation 316, the analytics server may store the segments of interest of the target cameras or any other media data from the warehouse cameras in accordance with the retention policy. The retention policy indicates to the database or analytics server one or more periods of time that data is stored and retained according to certain conditions. The retention policy may vary based upon a status and/or characteristics of the data. For instance, storing all of the media data generated by all of the cameras would greatly tax the digital storage resources, because the demands on the storage resources would quickly approach many terabytes of media data. One or more retention policies may help reduce the expected demands on the storage resources. The retention policies may configure the functions of the storage resources by, for example, indicating the period of time that certain data or certain storage locations retain data. The storage resources may be located on the database, the analytics server, and/or other devices of the system.

The storage resources may include one or more storage locations corresponding to retention policies configuring the comparatively longer-term and shorter-term storage memories (e.g., long-term storage, review queue). For example, the database includes the long-term storage that retains various types of data (e.g., media data, product data, camera data) for one or more years in accordance with the retention policy. The analytics server, however, includes the review queue that stores the media data (e.g., segments of interest, whole media data for a given workday) or other types of data associated with the each exception that is awaiting review by the reviewing worker. The analytics server retains the data associated with the exception for a comparatively shorter period of time (e.g., a day, a week, a month) as indicated by the retention policy. The analytics server may directly assign a different retention policy to the exception data (e.g., segments of interest, product data related to the exception) if the exception data should be retained for a longer period of time; or the analytics server may store the exception data into the long-term storage that retains the exception data in accordance to the different retention policy.

As another example, the retention policies may configure the storage resources to retain data according to the short-term storage (e.g., review queue), the long-term storage in the database, and an archive storage having the comparatively longest period for retaining data. In this example, the review queue retains the exception data at a relatively short period (e.g., day, week, month) and the long-term storage retains many types of data for a period of time that workers or other users would typically need to readily access and review the data (e.g., one or two years). The database may further include the archive storage that stores many types of data for an extended period of time or indefinitely, though the data may not need to be readily accessed or may be stored in a compressed format.

In some embodiments, the retention policies may configure the storage resources to retain the exception data according to the nature of the exception. For example, if the exception data indicates the exception relates to an incorrect product picked for an order, then the analytics server or database may assign a retention policy to the exception data having a relatively shorter-term (e.g., 6 months, 1 year), since the resolution of the exception may be relatively expeditious. If, however, the exception data indicates the exception relates to an incorrect replenishment of product inventory at an incorrect bin or missing products from an order where the picker is associated with many instances (above a threshold number) of the picker having missing products from many orders, then the analytics server or database may assign a retention policy to the exception data having a relatively longer-term (e.g., two or more years). As mentioned, in some implementations, when the product is misplaced at the wrong location during replenished, the product data in the database may be updated to reflect the new location (e.g., bin). It may be beneficial to maintain the exception data that precipitated such an update to the database records for future review by administrators. Similarly, it may be beneficial for warehouse managers to have extended access to review the actions of the picker having an unusual number of missing products when fulfilling orders.

In some embodiments, retention policies may instruct a shorter-term memory locations (e.g., review queue, long-term storage) to store media data at comparatively higher-quality and/or uncompressed formats. The retention policies may further instruct the longer-term memory locations (e.g., long-term storage, archive storage) to store media data at comparatively lower-quality and/or compressed formats. As an example, the review queue or long-term storage may store media data less than one year-old in higher quality and uncompressed. The retention policies may instruct the analytics server or database to reduce the quality (e.g., down-sample) of the media data and/or compress the media data after one year for archiving purposes. In some implementations, however, if the media data is associated with a confirmed exception, then the database stores the some or all of such media data in a higher quality and compressed by the database if possible without reducing the quality.

In some implementations, the analysis server or database may store the segment of interest of the media data of a camera that captured footage of the exception into the review queue, as well as adjacent segments of a given size on either side of the segment of interest (e.g., three total segments parsed from the media data of the camera). In this case, the analytics server or database stores the three segments according to the same retention policy. The analytics server may store the three segments in the storage resources together and assign the same retention policies to each of the three segments. In some cases, the analytics server may assign retention policies to the adjacent segments that reduce the requirements on the storage resources (e.g., shorter-term, reduced quality, compressed segments), but may assign retention policies to the segment of interest that maintains quality, does not compress the segment, or stores the segment for a longer-term.

In operation 318, the analytics server may generate and transmit a notification to the client device informing a worker (e.g., QA worker, reviewing worker, manager, picker) of the exception. For example, if the analytics server automatically detected an exception and/or confirmed the exception of a mispicked product at the packout station, then the analytics server may transmit a notification to the client device of the picker indicating that the picker picked the incorrect product when fulfilling the order. The notification may also include instructions to the worker for resolving the exception, for example indicating the correct product to pick and from where, and instructing the worker to return the mispicked product to its original location.

In operation 320, the analytics server may instruct the autonomous vehicle to redirect and move to an inspection station, which may be the packout station or other area of the warehouse. For example, if the analytics server automatically detects a potential exception using object recognition routines at the time the picker placed the product onto the autonomous vehicle, then the analytics server may instruct and re-direct the autonomous vehicle to the inspection station where a QA worker may manually inspect and input a confirmation or resolution input.

In operation 322, the analytics server may instruct the cameras to adjust (e.g., increase, decrease) the quality of the media data generated by the cameras. The database or analytics server may store the media data at a resolution quality based upon whether the media data is associated with the exception. As an example, the cameras may generate the media data at a higher resolution. If the analytics server receives the exception associated with the media data, then the media data is stored into a memory location at the higher resolution. If, however, the analytics server does not receive the exception associated with the media data or if the exception is not confirmed, then the analytics server degrades the quality of the media data and stores the media data at a lower resolution.

As another example, a particular camera may ordinarily generate media data at a lower resolution for bandwidth and storage considerations. In response to receiving the exception or confirmation of the exception, then the analytics server may adaptively instruct the camera to begin generating media data at a higher-resolution. For instance, the analytics server may treat an identified exception as a potential exception for confirmation by the reviewing worker. The analytics server may instruct the camera to begin generating the media data at the higher-resolution so that the resulting segment of interest would have the higher quality and be easier for a human worker to review and confirm.

In operation 324, the analytics server may update the product data stored in the database to reflect a new inventory storage location. For instance, when a picker replenishes the product inventory into a particular bin, the analytics server may identify or receive an exception indicating that the picker replenished product inventory in the incorrect bin, such that the bin contains the incorrect inventory products. Rather than moving the products to the originally correct bin, the analytics server may instead update the various types of data (e.g., product data, location/bin data, camera data) in the database to reassign and re-associate the products with the new bin. For instance, the analytics server may revise the various types of data to update which bin that a product SKU is assigned to after the products having that SKU were accidentally replenished into the wrong bin.

In some embodiments, a computer-implemented method comprises obtaining, by a computer, an exception associated with a product of an order; determining, by the computer, based upon the exception, a set of one or more cameras of a plurality of cameras, the set of one or more cameras having a field of view including an area for a transfer of the product of the order using an autonomous vehicle; for at least one camera of the set of one or more cameras: identifying, by the computer in media data received from the plurality of cameras, at least one segment of the media data received from the at least one camera corresponding to a time period relevant to the exception; and transmitting, by the computer to a client device, the identified at least one segment of the media data.

In some implementations, identifying the segment of the media data received from a particular camera in the set of one or more cameras further includes parsing, by the computer, the media data received from the particular camera according to one or more timestamps of product data and a segmenting configuration, thereby generating the segment of the media data for the particular camera.

In some implementations, determining the set of one or more cameras associated with the product of the order further includes correlating, by the computer, camera data associated with the plurality of cameras with product data to identify the set of one or more cameras, the camera data of each particular camera in the set of one or more cameras with the product of the order including one or more data intersections with the product data.

In some implementations, obtaining the exception associated with the order further includes: identifying, by the computer, one or more differences between the segment of the media data received from a particular camera of the set of one or more cameras and expected media data stored in the non-transitory storage; and detecting, by the computer, the exception for the product of the order responsive to the computer determining that the one or more differences satisfy a detection threshold.

In some implementations, the method further comprises storing, by the computer, into non-transitory storage the segment of the media data from the at least one camera of the set of one or more cameras according to a retention policy.

In some implementations, the method further comprises instructing, by the computer, the at least one camera of the set of one or more cameras to increase a media quality for the media data received from the at least one camera.

In some implementations, the method further comprises identifying, by the computer, a particular segment of the media data from the set of one or more cameras having an object image of the product.

In some implementations, the exception includes product data indicating the product of the order, the product data including at least one of: a product identifier, a scan of the product identifier, a product image, a bin identifier associated with the product, an autonomous vehicle identifier for the autonomous vehicle, a worker identifier, a worker image, or one or more timestamps.

In some embodiments, a system comprises a computer comprising a processor that is configured to obtain an exception associated with an product of an order; determine based upon the exception, a set of one or more cameras of a plurality of cameras, the set of one or more cameras having a field of view including an area for a transfer of the product of the order using an autonomous vehicle; for at least one camera of the set of one or more cameras: identify, in media data received from the plurality of cameras, at least one segment of the media data received from the at least one camera corresponding to a time period relevant to the exception; and transmit, to a client device, the identified at least one segment of the media data.

In some implementations, when identifying the segment of the media data received from the particular camera in the set of one or more cameras the computer is further configured to parse the media data received from the particular camera according to one or more timestamps of product data and a segmenting configuration, thereby generating the segment of the media data for the particular camera.

In some implementations, when determining the set of one or more cameras associated with the product of the order the computer is configured to correlate camera data associated with the plurality of cameras with product data to identify the set of one or more cameras, the camera data of each particular camera in the set of one or more cameras with the product of the order including one or more data intersections with the product data.

In some implementations, when obtaining the exception associated with the order the computer is further configured to identify one or more differences between the segment of the media data received from the particular camera and expected media data stored in the non-transitory storage; and detect the exception for the product of the order responsive to determining that the one or more differences satisfy a detection threshold.

In some implementations, the computer is further configured to store, into non-transitory storage, the segment of the media data from the at least one camera of the set of one or more cameras according to a retention policy.

In some implementations, the computer is further configured to instruct the at least one camera of the set of one or more cameras to increase a media quality for the media data received from the at least one camera.

In some implementations, the computer is further configured to identify a particular segment of the media data from the set of one or more cameras having an object image of the product.

In some implementations, the exception includes product data indicating the product of the order, the product data including at least one of: a product identifier, a scan of the product identifier, a product image, a bin identifier associated with the product, an autonomous vehicle identifier for the autonomous vehicle, a worker identifier, a worker image, or one or more timestamps.

In some embodiments, a non-transitory machine-readable storage medium having computer-executable instructions stored thereon that, when executed by one or more processors, cause the one or more processors to perform operations comprises obtaining an exception associated with an product of an order; determining based upon the exception, a set of one or more cameras of a plurality of cameras, the set of one or more cameras having a field of view including an area for a transfer of the product of the order using an autonomous vehicle; for at least one camera of the set of one or more cameras identifying, in media data received from the plurality of cameras, at least one segment of the media data received from the at least one camera corresponding to a time period relevant to the exception; and transmitting, to a client device, the identified at least one segment of the media data.

In some implementations, the computer-executable instructions further cause the one or more processors to perform the operations comprising parsing the media data received from the particular camera according to one or more timestamps of product data and a segmenting configuration, thereby generating the segment of the media data for the particular camera.

In some implementations, the computer-executable instructions further cause the one or more processors to perform the operations comprising correlating camera data associated with the plurality of cameras with product data to identify the set of one or more cameras, the camera data of each particular camera in the set of one or more cameras with the product of the order including one or more data intersections with the product data.

In some implementations, the computer-executable instructions further cause the one or more processors to perform the operations comprising identifying one or more differences between the segment of the media data received from the particular camera and expected media data stored in the non-transitory storage; and detecting the exception for the product of the order responsive to that computer determining that the one or more differences satisfy a detection threshold.

The foregoing method descriptions and the process flow diagrams are provided merely as illustrative examples and are not intended to require or imply that the operations of the various embodiments must be performed in the order presented. The operations in the foregoing embodiments may be performed in any order. Words such as “then,” “next,” etc. are not intended to limit the order of the operations; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The operations of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A computer-implemented method comprising:
obtaining, by a computer, an exception indicating a product identifier associated with a product of an order;
determining, by the computer, based upon the exception indicating the product identifier, a set of one or more cameras of a plurality of cameras based on product data associated with the product and camera data indicating the set of one or more cameras having corresponding fields of view including the product, at least one camera of the set of one or more cameras having a corresponding field of view including an area for a transfer of the product of the order using an autonomous vehicle;
for at least one camera of the set of one or more cameras:
identifying, by the computer in media data received from the plurality of cameras, at least one segment of the media data received from the at least one camera corresponding to a time period relevant to the exception; and
transmitting, by the computer to a client device, the identified at least one segment of the media data.

2. The method according to claim 1, wherein identifying the segment of the media data received from a particular camera in the set of one or more cameras includes:
parsing, by the computer, the media data received from the particular camera according to one or more timestamps of product data, thereby generating the segment of the media data for the particular camera.

3. The method according to claim 1, wherein determining the set of one or more cameras associated with the product of the order includes:
correlating, by the computer, camera data associated with the plurality of cameras with product data to identify the set of one or more cameras, the camera data of each particular camera in the set of one or more cameras with the product of the order including one or more data intersections with the product data.

4. The method according to claim 1, wherein obtaining the exception associated with the order includes:
identifying, by the computer, one or more differences between the segment of the media data received from a particular camera of the set of one or more cameras and expected media data stored in the non-transitory storage; and
detecting, by the computer, the exception for the product of the order responsive to the computer determining that the one or more differences satisfy a detection threshold.

5. The method according to claim 1, further comprising storing, by the computer, into non-transitory storage the segment of the media data from the at least one camera of the set of one or more cameras according to a retention policy.

6. The method according to claim 1, further comprising instructing, by the computer, the at least one camera of the set of one or more cameras to increase a media quality for the media data received from the at least one camera.

7. The method according to claim 1, further comprising identifying, by the computer, a particular segment of the media data from the set of one or more cameras having an object image of the product.

8. The method according to claim 1, wherein the exception includes product data indicating the product of the order, the product data including at least one of:
a product identifier,
a scan of the product identifier,
a product image,
a bin identifier associated with the product,
an autonomous vehicle identifier for the autonomous vehicle,
a worker identifier,
a worker image, or
one or more timestamps.

9. A system comprising:
a computer comprising a processor configured to:
obtain an exception indicating a product identifier associated with a product of an order;
determine based upon the exception indicating the product identifier, a set of one or more cameras of a plurality of cameras based on product data associated with the product and camera data indicating the set of one or more cameras having corresponding fields of view including the product, at least one camera of the set of one or more cameras having a corresponding field of view including an area for a transfer of the product of the order using an autonomous vehicle;
for at least one camera of the set of one or more cameras:
identify, in media data received from the plurality of cameras, at least one segment of the media data received from the at least one camera corresponding to a time period relevant to the exception; and
transmit, to a client device, the identified at least one segment of the media data.

10. The system according to claim 9, wherein when identifying the segment of the media data received from the particular camera in the set of one or more cameras, the computer is further configured to:
parse the media data received from the particular camera according to one or more timestamps of product data, thereby generating the segment of the media data for the particular camera.

11. The system according to claim 9, wherein when determining the set of one or more cameras associated with the product of the order, the computer is configured to:
correlate camera data associated with the plurality of cameras with product data to identify the set of one or more cameras, the camera data of each particular camera in the set of one or more cameras with the product of the order including one or more data intersections with the product data.

12. The system according to claim 9, wherein when obtaining the exception associated with the order, the computer is further configured to:
identify one or more differences between the segment of the media data received from the particular camera and expected media data stored in the non-transitory storage; and
detect the exception for the product of the order responsive to determining that the one or more differences satisfy a detection threshold.

13. The system according to claim 9, wherein the computer is further configured to store, into non-transitory storage, the segment of the media data from the at least one camera of the set of one or more cameras according to a retention policy.

14. The system according to claim 9, wherein the computer is further configured to instruct the at least one camera of the set of one or more cameras to increase a media quality for the media data received from the at least one camera.

15. The system according to claim 9, wherein the computer is further configured to identify a particular segment of the media data from the set of one or more cameras having an object image of the product.

16. The system according to claim 9, wherein the exception includes product data indicating the product of the order, the product data including at least one of:
a product identifier,
a scan of the product identifier,
a product image,
a bin identifier associated with the product,
an autonomous vehicle identifier for the autonomous vehicle,
a worker identifier,
a worker image, or
one or more timestamps.

17. A non-transitory machine-readable storage medium having computer-executable instructions stored thereon that, when executed by one or more processors, cause the one or more processors to perform operations comprising:
obtaining an exception indicating a product identifier associated with an product of an order;
determining based upon the exception indicating the product identifier, a set of one or more cameras of a plurality of cameras based on product data associated with the product identifier and camera data indicating the set of one or more cameras having corresponding fields of view including the product, at least one camera of the set of one or more cameras having a corresponding field of view including an area for a transfer of the product of the order using an autonomous vehicle;
for at least one camera of the set of one or more cameras:
identifying, in media data received from the plurality of cameras, at least one segment of the media data received from the at least one camera corresponding to a time period relevant to the exception; and
transmitting, to a client device, the identified at least one segment of the media data.

18. The non-transitory machine-readable storage medium of claim 17, wherein the computer-executable instructions further cause the one or more processors to perform the operations comprising:
parsing the media data received from the particular camera according to one or more timestamps of product data, thereby generating the segment of the media data for the particular camera.

19. The non-transitory machine-readable storage medium of claim 17, wherein the computer-executable instructions further cause the one or more processors to perform the operations comprising:
correlating camera data associated with the plurality of cameras with product data to identify the set of one or more cameras, the camera data of each particular camera in the set of one or more cameras with the product of the order including one or more data intersections with the product data.

20. The non-transitory machine-readable storage medium of claim 17, wherein the computer-executable instructions further cause the one or more processors to perform the operations comprising:
identifying one or more differences between the segment of the media data received from the particular camera and expected media data stored in the non-transitory storage; and
detecting the exception for the product of the order responsive to that computer determining that the one or more differences satisfy a detection threshold.
